(19) United States
(12) Patent Application Publication
(10) Pub. No.: US 2010/0131514 A1
(43) Pub. Date: May 27, 2010

(54) REAL-TIME AUTOMATIC SEARCHING SYSTEM FOR MEDICAL IMAGE AND METHOD FOR USING THE SAME

(75) Inventor: WILLIAM PAN, TAIPEI (TW)

Correspondence Address: ROSENBERG, KLEIN & LEE, 3458 ELLICOTT CENTER DRIVE-SUITE 101, ELLICOTT CITY, MD, 21043, US

(73) Assignee: EBM TECHNOLOGIES INCORPORATED, TAIPEI (TW)

(21) Appl. No.: 12/693,743

(22) Filed: Jan. 26, 2010

Related U.S. Application Data
(63) Continuation-in-part of application No. 10/873,247, filed on Jun. 23, 2004.

(51) Int. Cl. G06F 17/30

(52) U.S. Cl. 707/741; 707/748; 707/E17.019; 707/E17.014; 707/E17.002

(57) ABSTRACT

A real-time automatic searching method for a medical image is disclosed. The method includes in response to a search command for a first image identifying a difference between a first searchable information and a second searchable information, applying a predetermined set of weights to the first searchable information according to the difference, calculating a weighted index for the first image after applying the predetermined weights to the first searchable information, and locating the first image according to the weighted index.

### CROSS-REFERENCE TO RELATED APPLICATIONS

The present invention is a Continuation-in-Part of and claims priority to patent application Ser. No. 10/873,247, filed on Jun. 23, 2004, entitled “REAL-TIME AUTOMATIC SEARCHING SYSTEM FOR MEDICAL IMAGE AND METHOD FOR THE SAME,” which is currently pending.

### BACKGROUND OF THE INVENTION

1. Field of the Invention

The present invention relates to a real-time automatic searching system for a medical image and method for using the same and more particularly, to a real-time automatic searching system for a medical image that is capable of locating the medical image of higher relevance and a method for using the same.

2. Description of Related Art

A conventional automatic searching system for a medical image generally requires the medical practitioner to input keywords along with the medical image to be stored. The keywords may include a number of the patient, a term describing a symptom, or a string of words providing more details regarding the patient before the medical image could be stored into a database. Thus, when the medical practitioner searches for the medical image of the same patient or other patients with the similar symptoms for the diagnosis he/she usually has to input the keywords utilized before in order to obtain the medical image.

As the medical practitioner may be without the knowledge of the keywords used earlier, he/she may not be able to obtain the stored medical image for his/her reference, potentially undermining the quality of medical care. On the other hand, the medical practitioner may be overwhelmed by an excessive amount of the medical images when searching for the reference images without knowledge or experience of using a searching system, still causing headaches for the medical practitioner.

### SUMMARY OF THE INVENTION

A real-time automatic searching method for a medical image is disclosed. The method includes in response to a search command for a first image identifying a difference between a first searchable information and a second searchable information, applying a predetermined set of weights to the first searchable information according to the difference, calculating a weighted index for the first image after applying the predetermined weights to the first searchable information, and locating the first image according to the weighted index.

The above summaries are intended to illustrate exemplary embodiments of the invention, which will be best understood in conjunction with the detailed description to follow, and are not intended to limit the scope of the appended claims.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 shows a simplified block diagram of a real-time automatic searching system for a medical image according to one embodiment of the present invention.

FIG. 2 shows a flow chart of a process performed by a real-time automatic searching system according to one embodiment of the present invention.

FIG. 3 shows a flow chart of a process for a real-time automatic searching system to interface a medical practitioner according to one embodiment of the present invention.

FIG. 4A is a schematic diagram showing a pop-up window before a search for a first image is conducted according to one embodiment of the present invention.

FIG. 4B is a schematic diagram showing another pop-up window when an option of a manual input of information associated with an attribute is selected according to one embodiment of the present invention.

FIG. 5 is a schematic diagram showing a result of a search for a first image according to one embodiment of the present invention.

### DETAILED DESCRIPTION OF THE PREFERRED EMBODIMENTS

While the present invention will be described more fully hereinafter with reference to the accompanying drawings, in which a preferred embodiment(s) of the present invention is shown, it is to be understood at the outset of the description which follows that persons of skill in the appropriate arts may modify the invention here described while still achieving the favorable results of the invention. Accordingly, the description which follows is to be understood as being a broad, teaching disclosure directed to persons of skill in the appropriate arts, and not as limiting upon the present invention.

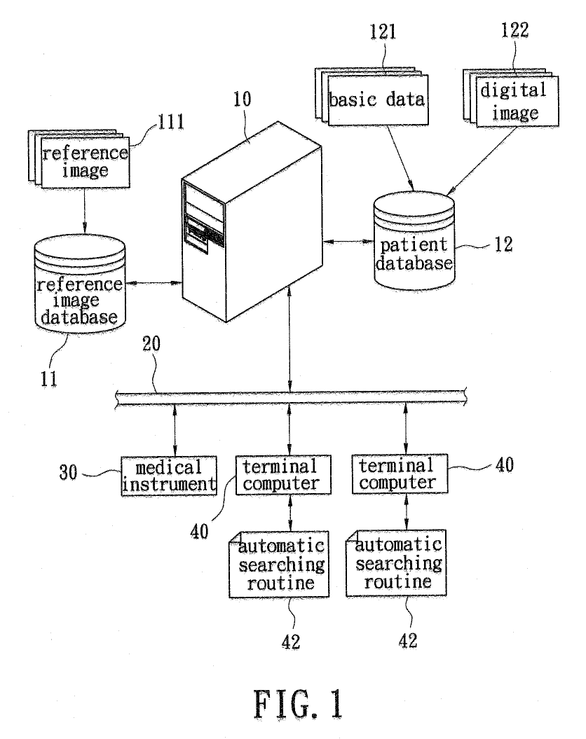

FIG. 1 shows a simplified block diagram of a real-time automatic searching system for a medical image according to one embodiment of the present invention. The real-time automatic searching system for the medical image is employed in a medical intuition such as a hospital to provide the medical practitioners such as doctors with relevant medical images in response to their search demands. The real-time automatic searching system according to the present invention comprises a remote host 10, at least one medical instrument 30 and a plurality of terminal computers 40. The remote host 10 is connected to the medical instrument 30 and the terminal computers 40 through a network 20 such as a local area network (LAN), Internet or wireless network.

The remote host 10 comprises a reference image database 11 and a patient database 12. The reference image database 11 stores a plurality of reference images 111 including images for healthy people and images for patients with specific diseases. Moreover, the reference images 111 in the reference image database 11 are associated with a first searchable information. In one implementation, the first searchable information is a name of a directory where the first image is stored. For example, the reference image from a person whose year of birth is 1976 may be stored in the directory of “DOB_{—}1976” of the reference image database 11. Thus, when a search command of “Year_{—}1976” is inputted such reference image may be returned. In another implementation, the first searchable information includes a set of attributes. For example, the attributes include the gender, the age, the race, and/or the body portion (e.g., a particular organ with a symptom). Thus, the reference image 111 could be with the attributes of “Caucasian-male-age 55-lung cancer.” Therefore, when another search command of “Caucasian male of age between 50 to 60” is inputted such first image may be returned.

The patient database 12 stores basic data 121 of a patient who is now being diagnosed and digital image 122 for the same patient. In one implementation, the basic data 121 includes the patient's basic information such as the medical record number, name, age, and gender, and the patient's examination information including but not limited to examination number, body portion, the symptom of illness. It is worth noting that the reference image database 11 and the patient database 12 could be in a same or separated storage device of the present searching system for the medical image.

The digital image 122 of the patient may be generated by the medical instrument 30 and may be stored into the patient database 12 along with a second searchable information. In one implementation, the second set of the attributes may include attributes such as the gender, the age, the symptom, and the examination number. Thus, the digital image of the patient 122 could be represented as “age 35-stomach cancer-0001234.” When a search command such as “examination number of 0001234” is inputted, that particular digital image of the patient 122 may be located.

The medical instrument 30 could be compatible with digital image communication in medicine (DICOM) format and equipped with DICOM console to generate the digital image 122 of the patient in DICOM format. The medical instrument 30 can be, for example, an X-ray imager, an angiography camera, an interiorly camera or a tomography imager.

The terminal computer 40 is configured to access the patient database by connecting to the remote host 10 through the network 20 and to display the basic data 121 and the digital image 122. The terminal computer 40 is configured to access the reference image database as well. To access both of the reference image database and the patient database, the terminal computer 40 further includes an automatic searching routine 42 for fetching the basic data 121 of patient and searching for the reference image 111.

When the search command is inputted through the automatic searching routine 42, the host computer 10 may return the basic data 121 and the digital image 122 of the patient, and the reference image 111 to the medical instrument 30 and/or the terminal computer 40. The reference image 111 is displayed on a display device (not shown) of the terminal computer 40 for the medical practitioner to make a diagnosis for the patient. An ideal situation is the returned reference image is the image of the same body portion with the same symptom from the person of the similar age and of the same gender. For example, when the digital image of the patient 122 is from a male of age 55 having a lung cancer and the reference image 111 is from a male of age 60 having a lung cancer it would be easier for the medical practitioner to determine the course of future treatment.

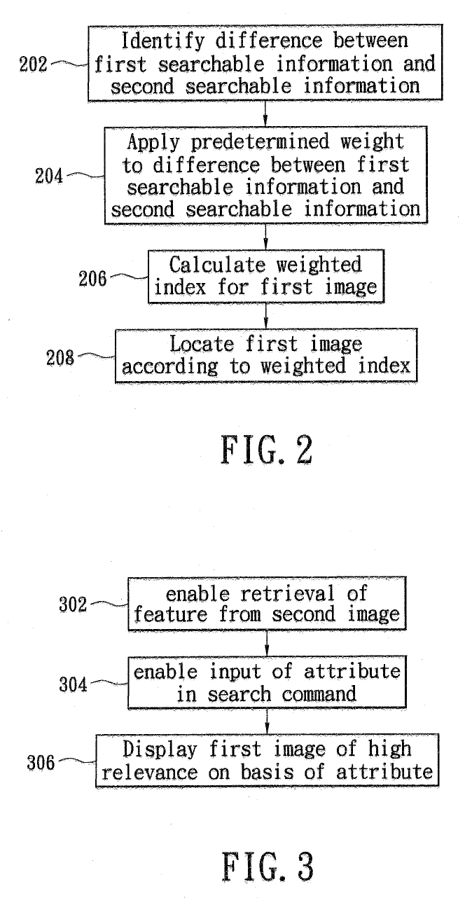

Please refer to FIG. 2 of a flow chart showing a process performed by a real-time automatic searching system according to one embodiment of the present invention. In order to return the reference image that could be more helpful for the medical practitioner, the automatic searching system according to the present invention may perform the steps including step 202 in which the system is configured to identify a difference between a first searchable information and a second searchable information, step 204 in which the system is configured to apply a predetermined weight to the difference identified in step 202, step 206 in which the system is configured to calculate a weighted index for the first image after applying the weight to the difference between the first searchable information and the second searchable information, and step 208 in which the system is configured to locate the first image according to the weighted index.

In one implementation, the first image is a reference image such as the reference image 111 in FIG. 1, while the second image is the digital image of the patient such as the digital image of the patient 122 in FIG. 1. It is possible that the second searchable information may be partially or totally different to the first searchable information, thus the step of identifying the difference between the first searchable information and the second searchable information may determine whether any attribute (e.g., age) is utilized in both of the first searchable information and the second searchable information. If so, step 202 may further compute the difference in such attribute between the first image and the second image. For example, when the first image that is associated with the attribute of “age” is from a 50-year old and the second image that is associated with the same “age” attribute is from a person of 60 years old step 202 may conclude that the first image is “10 years away” from the second image after identifying the difference in the “age” attribute. In another implementation, the first searchable information and the second searchable information could be substantially the same. Thus, the step of identifying the difference between the first searchable information and the second searchable information is configured to compute the difference between the first searchable information and the second searchable information.

Step 204 applies the predetermined weight to the difference identified in step 202. A table shown in the below is an example showing the weights applied to the difference between the attributes.

| | weight |
|---|---|
| Age difference (year) | |
| 0~10 | 4 |
| 11-20 | 3 |
| 21-30 | 2 |
| 31-40 | 1 |
| Gender | |
| Same | 4 |
| Different | 2 |
| Body portion | |
| Same | 3 |
| Relevant | 1 |
| Symptom relevance | |
| Different development | 0 |
| period in different | |
| body portion | |
| Same development | 2 |
| period in different | |
| body portion | |
| Different development | 4 |
| period in same body | |
| portion | |
| Same development | 8 |
| period in same body | |
| portion | |

When the difference in the age attribute is larger, the weight applied could be smaller. In other words, the process according to the present invention gives more weight to the reference image from the person of the similar age. The present process may apply more weights to the reference image from the person of the same gender when the gender is the attribute utilized in both sets of the attributes. Additionally, step 204 applies more weights to the reference image regarding the same body portion as the second image from the patient. Meanwhile, the step 204 also applies more weights to the symptoms of the same development period and associated with the same body portion (e.g., lung cancer of development period 3). It is worth noting that the weights applied are adjustable according to the empirical analysis indicative of which difference between the attributes of the searchable information and the extent thereof could lead to the reference image of more reference value.

Step 206 calculates the weighted index after the application of the weights to the difference identified. In one implementation, when the weights applied are larger the weighted index could be larger as well and the larger weighted index may correspond to the reference image of higher relevance. Step 308 then locates the first image according to the weighted index calculated in step 306. When the first image of larger weighted index corresponds to the first image of higher relevance, such first image may be located and presented. It is worth noting that the number of the first images located according to the weighted index may vary. In one implementation, when two first image are with the weighted index larger than a predetermined threshold these first images are to be located and presented. And the sequence of the presentation may depend on the value of the weighted index.

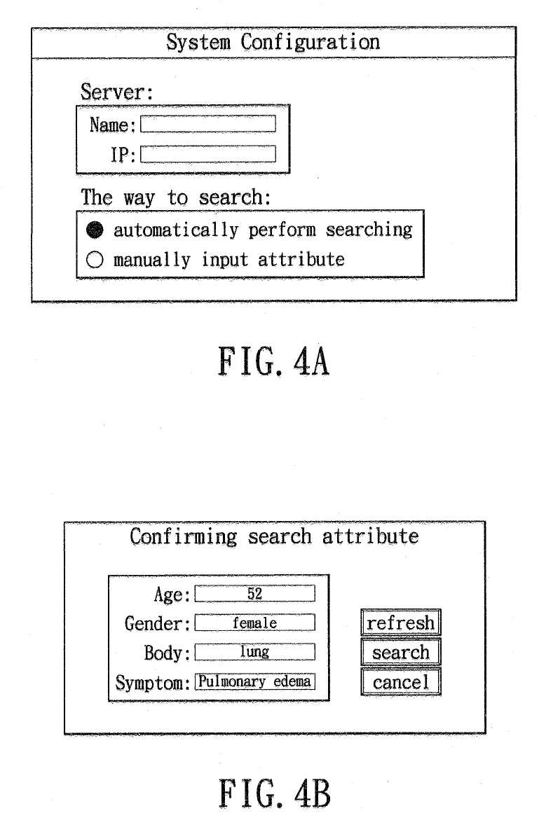

FIG. 3 is a flow chart showing a process for a real-time automatic searching system to interface a medical practitioner according to one embodiment of the present invention. In step 302, the present invention system is configured to enable a retrieval of a feature from a second image as an attribute of a first searchable information associated with the second image. In step 304, the present invention system is configured to enable an input of an attribute in a search command for a search of a first image. In step 306, the present invention system is configured to display a first image of high relevance on basis of the attribute.

In conjunction with FIG. 1, the first image could be the reference image 111 stored in the reference image database 11 while the second image could be the digital image of the patient 122 stored in the patient database 12. When any medical instrument 30 generates the second image the present invention system in step 302 may retrieve features of the second image by any conventional image recognition approach. The retrieved feature of the second image may become one attribute thereof. For example, when the second image is an X-ray image of the patient's lung the system may recognize that particular image to generate the attributes of “lung” and “cancerous cells spotted in lung.” And such attributes may be considered as the first searchable information for the search of the first image. It is worth noting that the attribute associated with the second image could be manually inputted by the medical practitioner also.

Meanwhile, the present invention system in step 304 may enable the input of the attribute in the search command for the first image. For example, the present invention could display a pop-up window for the medical practitioner to enter, these attributes and their corresponding information. For example, the present invention system may allow the input of “age-55,” “gender-male,” “race-Caucasian,” and “body portion-lung” when formulating the search command for the first image. In step 306, the present invention system 306 may display the first image of high relevance computed through the steps discussed in FIG. 2 on basis of the attributes. It is worth noting that the present invention system may search for the first image of high relevance according to the attributes. In other words, when the attribute is retrieved by image recognition of the second image the present invention system may conduct the search thereafter according to the retrieved attribute only. In doing so, the system may respond with more first images as the result of lack of the input of the corresponding information for the attribute (e.g., 55, male, or Caucasian) that is used for narrowing the scope of the search.

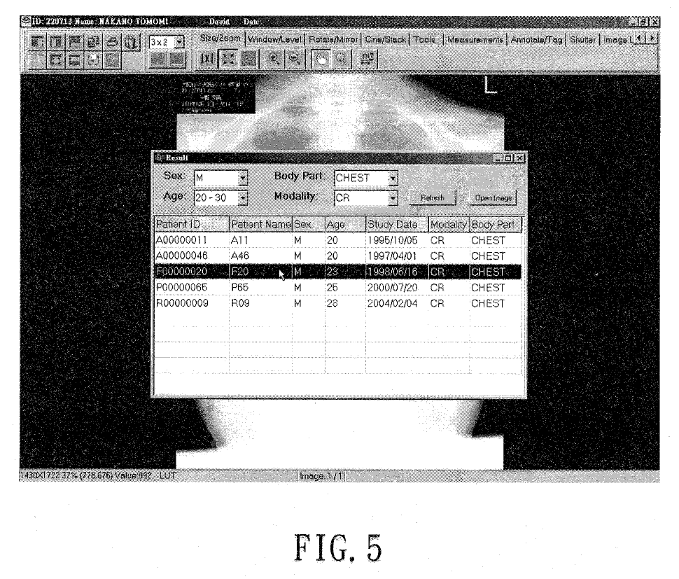

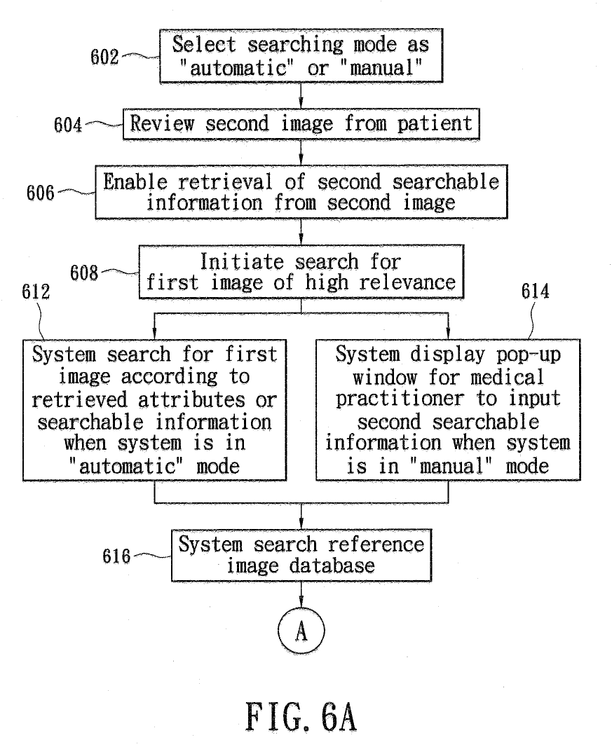

FIG. 4A is a schematic diagram showing a pop-up window before a search for a first image is conducted according to one embodiment of the present invention. As previously mentioned, the present invention system may search for the first image according to the attributes without further narrowing the scope of the search. To do so, the medical practitioner could check the option of “automatically perform searching” as shown in FIG. 4A before the system could proceed to the search for the first image.

FIG. 4B is a schematic diagram showing another pop-up window when an option of a manual input of information associated with an attribute is selected according to one embodiment of the present invention. In conjunction FIG. 4A, when the option of “manually input information associated with attribute” is selected another window may shown for the input of the attribute. As shown in FIG. 4B, the medical practitioner may input the age, the gender, the body portion, and the symptom of the patient before the present invention system could return any first image.

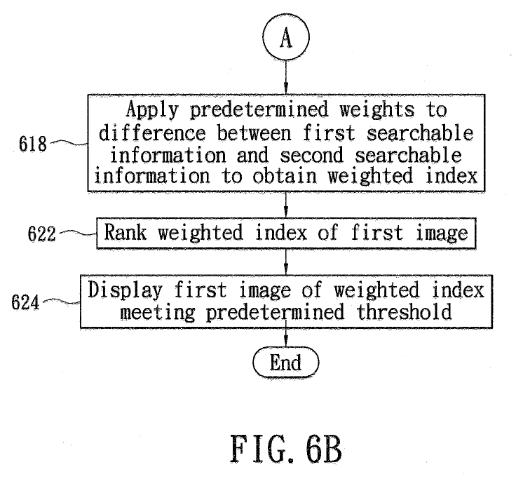

FIG. 5 is a schematic diagram showing a result of a search for a first image according to one embodiment of the present invention. As shown in FIG. 5, the result of the search may include more than one reference image of high relevance. The result of the search may also display the information associated with the attributes utilized in the search and the information could be changed if another search for the first image is requested.

FIG. 6A is a flow chart showing steps for a medical practitioner to utilize a real-time automatic searching system according to one embodiment of the present invention. In step 602, the medical practitioner may select a searching mode in which the real-time automatic searching system operates. In one implementation, the searching mode includes “automatic” and “manual” as shown in FIGS. 4A and 4B. In step 604, the medical practitioner may review a second image from a patient. In step 606, the medical practitioner may enable a retrieval of features from the second image. In step 608, the medical practitioner may initiate a search for a first image of high relevance by pushing a “search” button. In step 612, when the automatic searching system is in the “automatic” searching mode the system may search for the first image of high relevance according to the features retrieved from the second image or the second searchable information associated with the second image. In step 614, when the system is in the “manual” mode the system display a pop-up window for the medical practitioner to input the second searchable information on which basis the system may search for the first image stored in a reference image database in step 616.

Please refer to FIG. 6B of a flow chart showing steps for the medical practitioner to utilize the real-time automatic searching system according to one embodiment of the present invention. It is worth noting that the steps shown in FIG. 6B may follow the steps in FIG. 6A. In step 618, the system may apply a predetermined set of weights to a difference between the first searchable information and the second searchable information in order to obtain a weighted index according to the difference for each of the first images. In step 622, the system may rank the first images according to their weighted indices. And in step 624 the system may display the first images of the weighted indices meeting a predetermined threshold. In other words, the predetermined threshold may be used for reducing the number of the first images. Thus, the medical practitioner may obtain the images of higher reference value when determining the course of the future treatment for the patient associated with the second image.

The above-mentioned descriptions represent merely the preferred embodiment of the present invention, without any intention to limit the scope of the present invention thereto. Various equivalent changes, alternations or modifications based on the claims of present invention are all consequently viewed as being embraced by the scope of the present invention.

What is claimed is:

1. A real-time automatic searching method for a medical image in a computer system having a memory unit storing a first image associated with a first searchable information and a second image associated with a second searchable information, comprising:
in response to a search command for the first image identifying a difference between the first searchable information and the second searchable information;
applying a predetermined set of weights to the first searchable information according to the difference;
calculating a weighted index for the first image after applying the predetermined weights to the first searchable information; and
locating the first image according to the weighted index.

2. The real-time automatic searching method as in claim 1, wherein identifying the difference further comprises computes the difference between the first searchable information and the second searchable information.

3. The real-time automatic searching method as in claim 1, further comprising determining whether the weighted index meets a predetermined threshold.

4. The real-time automatic searching method as in claim 3, further comprising displaying the first images in a predetermined sequence when each of the first images is with the weighted index meeting the predetermined threshold wherein the predetermined sequence is set according to the weighted index of the first image.

5. The real-time automatic searching method as in claim 1, further comprising retrieving a feature from the second image.

6. The real-time automatic searching method as in claim 1, further comprising enabling an input of an attribute of the first searchable information before identifying the difference between the first searchable information and the second searchable information.

7. A computer system, comprising:
a processing unit; and
a memory unit storing a first image associated with a first searchable information and a real-time automatic searching application program wherein the real-time automatic searching application program is configured to:
in response to a search command for the first image identify a difference between the first searchable information and a second searchable information associated with a second image;
apply a predetermined set of weights to the first searchable information according to the difference;
calculate a weighted index for the first image after applying the predetermined weights to the first searchable information; and
locate the first image according to the weighted index.

8. The computer system of claim 7 wherein the memory unit is configured to store the second image.

9. The computer system of claim 7 wherein the real-time automatic searching application program is configured to compute the difference between the first searchable information and the second searchable information.

10. The computer system of claim 7 wherein the real-time automatic searching application program is configured to determine whether the weighted index meets a predetermined threshold.

11. The computer system of claim 10 wherein the real-time automatic searching application program is further configured to display the first images in a predetermined sequence when each of the first images is with the weighted index meeting the predetermined threshold wherein the predetermined sequence is set according to the weighted index of the first image.

12. The computer system of claim 7 wherein the real-time automatic searching application program is further configured to retrieve a feature from the second image.

13. The computer system of claim 7 wherein the real-time automatic searching application program is further configured to enable an input of an attribute of the first searchable information before identifying the difference between the first searchable information and the second searchable information.

14. A computer-readable medium containing a sequence of instructions executable within a computer system having a processing unit and a memory unit, wherein the sequence of instructions, when executed by the processing unit, causes the processing unit to:
in response to a search command for the first image identify a difference between the first searchable information and a second searchable information associated with a second image;
apply a predetermined set of weights to the first searchable information according to the difference;
calculate a weighted index for the first image after applying the predetermined weights to the first searchable information; and
locate the first image according to the weighted index.

15. The computer-readable medium of claim 14, further comprising a sequence of instructions when executed by the processing unit causes the processing unit to compute the difference between the first searchable information and the second searchable information.

16. The computer-readable medium of claim 14, further comprising a sequence of instructions when executed by the processing unit causes the processing unit to determine whether the weighted index meets a predetermined threshold.

17. The computer-readable medium of claim 16, further comprising a sequence of instructions when executed by the processing unit causes the processing unit is further configured to display the first images in a predetermined sequence when each of the first images is with the weighted index meeting the predetermined threshold wherein the predetermined sequence is set according to the weighted index of the first image.

18. The computer-readable medium of claim 14, further comprising a sequence of instructions when executed by the processing unit causes the processing unit to retrieve a feature from the second image.

19. The computer-readable medium of claim 14, further comprising a sequence of instructions when executed by the processing unit causes the processing unit to enable an input of an attribute of the first searchable information.
